(19) United States
(12) Patent Application Publication
(10) Pub. No.: US 2007/0101356 A1
(43) Pub. Date: May 3, 2007

(54) Systems and methods for controlling access for use with intelligent data management arrangements

(76) Inventor: Craig Walrath, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/262,076

(22) Filed: Oct. 27, 2005

(51) Int. Cl. H04N 7/16

(52) U.S. Cl. 725/25; 725/30; 725/28

(57) ABSTRACT

An access control system for use with an intelligent data management arrangement (IDMA) is presented including: a source component for providing a content signal originating from a content source; a destination component for receiving the content and for optionally displaying the content signal on a destination device; and an IDMA in electronic communication with the source component and the destination component, the IDMA including, a content control component for controlling access of the content source, and a display control component for controlling access of the destination device. In some embodiments, the content control component is configured to: block the content source from receiving the content signal; block the content source from sending the content signal; block the destination device from receiving the content signal; and block the destination device from displaying the content signal.

### CROSS REFERENCE TO RELATED APPLICATIONS

The present invention is related to the following applications, all of which are incorporated herein by reference:

Commonly assigned application entitled “METHODS AND SYSTEMS FOR CONTENT DISTRIBUTION USING INTELLIGENT DATA MANAGEMENT ARRANGEMENTS,” filed on even date herewith by the same inventors herein (Attorney Docket Number 200503901-1); and

Commonly assigned application entitled “SYSTEMS AND METHODS FOR PROCESSING REMOTE CONTROL SIGNALS,” filed on even date herewith by the same inventors herein (Attorney Docket Number 200503903-1).

### BACKGROUND

The use of media in modern technological societies has multiplied at an astonishing rate. New content is continually being produced in response to this rise of use. With the production of new content invariably come issues focusing on what content may or may not be objectionable to viewers. In the past, the availability of objectionable material was limited. However, with the plethora of media devices and media avenues available to consumers, wider ranges of content are now readily available to users. Some solutions to controlling access to content include simply unplugging an offending device. Others have incorporated ratings guides limiting access for a particular device. However, each of these solutions is device specific and may not consistently control access devices. Further, configuration of these devices may not be uniform thus increasing inconsistency across devices. Finally, configuration may be further complicated by two or more display devices connected with a content source. As can be appreciated, inconsistent access and difficult configuration may present users with particular disadvantages.

For example, FIG. 1 is a diagrammatic representation of video distribution system 100. As illustrated, any number of devices such as 120, 122, 124, 126, 128, 130, and 132 may be connected with television 136 via receiver/switch 134. In some examples, television 136 may be configured for direct connection with devices 120, 122, 124, 126, 128, 130, and 132. As can be appreciated, devices may provide viewing content for a user in accordance with user preferences. In some examples, receiver/switch 134 may be configured to accept a variety of television standards. In addition, any number of remote controls 102-118 may be used to control devices 120, 122, 124, 126, 128, 130, and 132, receiver/switch 134, and television 136. As can be appreciated, although these devices may, in some examples, be easily configured, these examples are not without their disadvantages.

For example, as the number of devices increase, so do the cabling requirements. In some examples, video and audio portions of a television signal may be split into three signals for video and stereo audio. Thus three cables for each device may result in as many as 21 cables for the configuration illustrated. Compounding the problem are devices that require a return path for recording thus further increasing the potential number of cables. Additionally, configurations requiring a separate remote for each device may result in numerous remote control units each containing different functionality and layouts, which can easily confuse a user. Still further, configurations containing multiple devices of the same manufacturer may suffer from cross-talk in remote commands. That is, for example, if DVD 122 and DVD 124 were the same model, both would respond to a common remote control command. Thus, a user desiring to control the devices separately would either need to cover or disable one of the remote control receiving sensors while issuing remote commands or place the devices in separate locations to prevent unwanted functions from being implemented on both devices. Thus, methods for effectively configuring and controlling content distribution systems may be desirable.

Further, prior art examples often require all devices to be located in a common area so as to facilitate control of devices. More often than not, devices must be located at or near a designated viewing area therefore restricting the use of those devices to that area. Although additional cabling may allow viewing of content in other areas, the inability to control the devices from another location may diminish a user's viewing experience. Still further, in those examples where additional cabling may be utilized as a solution, it can be appreciated that standard cabling often offers an all-or-nothing approach. That is, a user may not easily restrict content from a particular device to a particular viewing area since all the content is directed through the cable. Certainly, sophisticated switches and multiple cable feeds may be utilized to restrict access to a device, however, those solutions are generally solely device-restrictive (as opposed to content-restrictive) and are generally costly to implement. Thus method for managing access to content in content distribution systems may be desirable.

In another example, FIG. 2 is a diagrammatic representation of a video distribution system 200 utilizing a universal remote 202. As noted above for FIG. 1, configurations requiring separate remotes for each input device may result in numerous remote control units each containing different functionality and layouts, which can easily confuse a user. FIG. 2 illustrates one prior art solution that attempts to reduce the number and types of remotes. In those embodiments, universal remote 202 may be configured to “learn” the remote commands for each input device 204-216. In some examples, universal remote 202 may also “learn” television 220 remote commands as well as receiver/switch 218 remote commands. This configuration, however, is not without its attendant disadvantages.

For example, universal remotes may still suffer from cross-talk in remote commands. That is, for example, if DVD 206 and DVD 208 were the same model, both would respond to a common remote control command. Thus, a user desiring to control the input devices separately would either need to cover or disable one of the remote control receiving sensors while issuing remote commands from a universal remote or place the input devices in separate locations to prevent unwanted functions from being implemented on both input devices. Still further, many universal remote configurations include multiple screens or template that are required to accommodate disparate functionality between devices. Often these templates are difficult to read especially when used in a viewing environment that is not always well lit. Thus, methods for managing remote control signals may be desirable.

As such, systems and methods for processing remote control systems are presented herein.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagrammatic representation of a video distribution system;

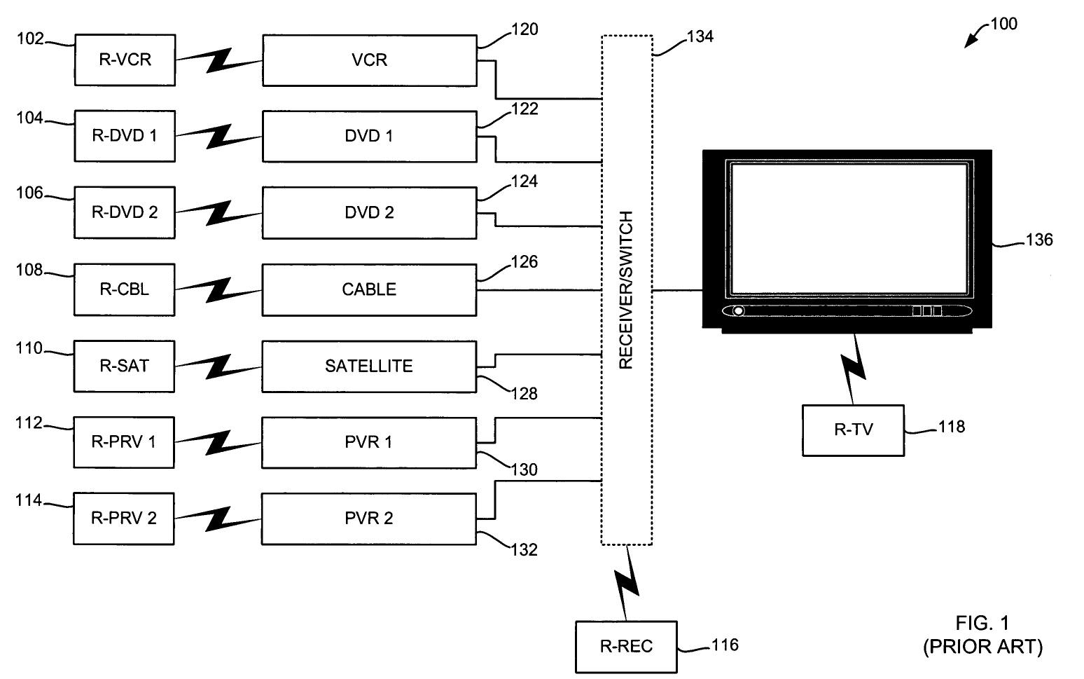

FIG. 2 is a diagrammatic representation of a video distribution system utilizing a universal remote;

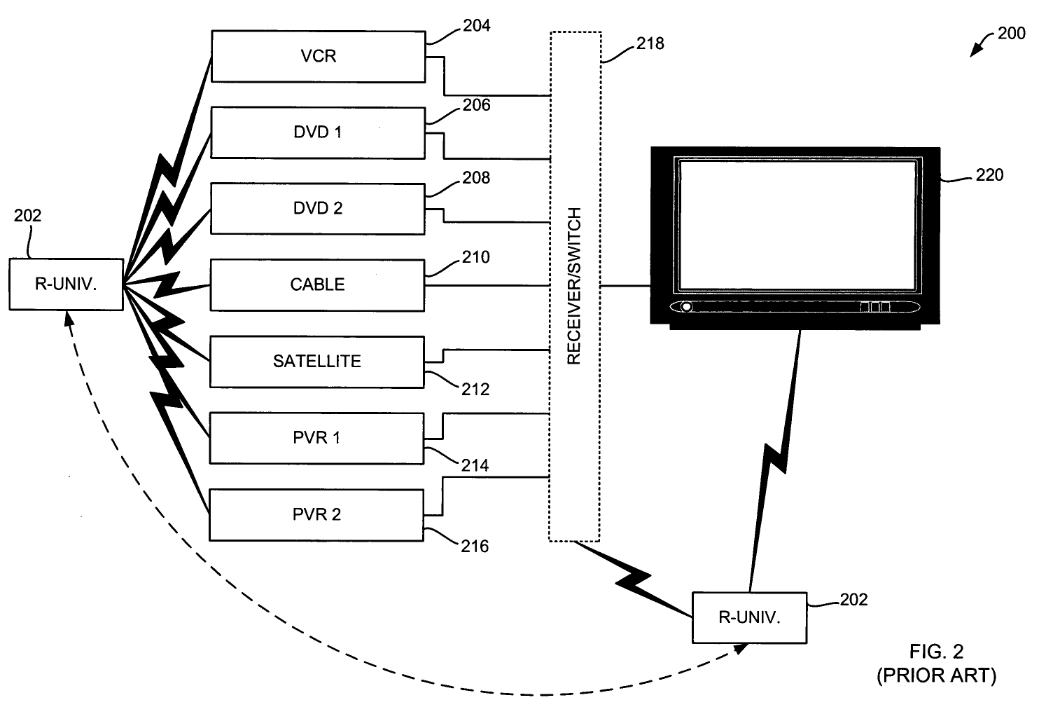

FIG. 3 is a diagrammatic representation of signal paths in accordance with an embodiment of the present invention;

FIG. 4 is a diagrammatic representation of a functional view of an intelligent data management arrangement (IDMA) in accordance with an embodiment of the present invention;

FIG. 5 is a diagrammatic flowchart of a method of configuring an IDMA for use with a content source in accordance with an embodiment of the present invention;

FIG. 6 is a diagrammatic flowchart of a method of configuring an IDMA for use with a display in accordance with an embodiment of the present invention;

FIG. 7 is a diagrammatic representation of signal paths of a content signal in accordance with embodiments of the present invention;

FIG. 8 is a diagrammatic representation of a legacy system overview in accordance with an embodiment of the present invention;

FIG. 9 is a diagrammatic representation of a legacy combination system overview in accordance with an embodiment of the present invention;

FIG. 10 is a diagrammatic representation of a legacy combination system overview in accordance with an embodiment of the present invention;

FIG. 11 is a diagrammatic representation of an integrated system overview in accordance with an embodiment of the present invention;

FIG. 12 is a diagrammatic flowchart of a method of processing a remote control signal in accordance with an embodiment of the present invention; and

FIG. 13 is a diagrammatic representation of access control configurations in accordance with an embodiment of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to preclude obscuring the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

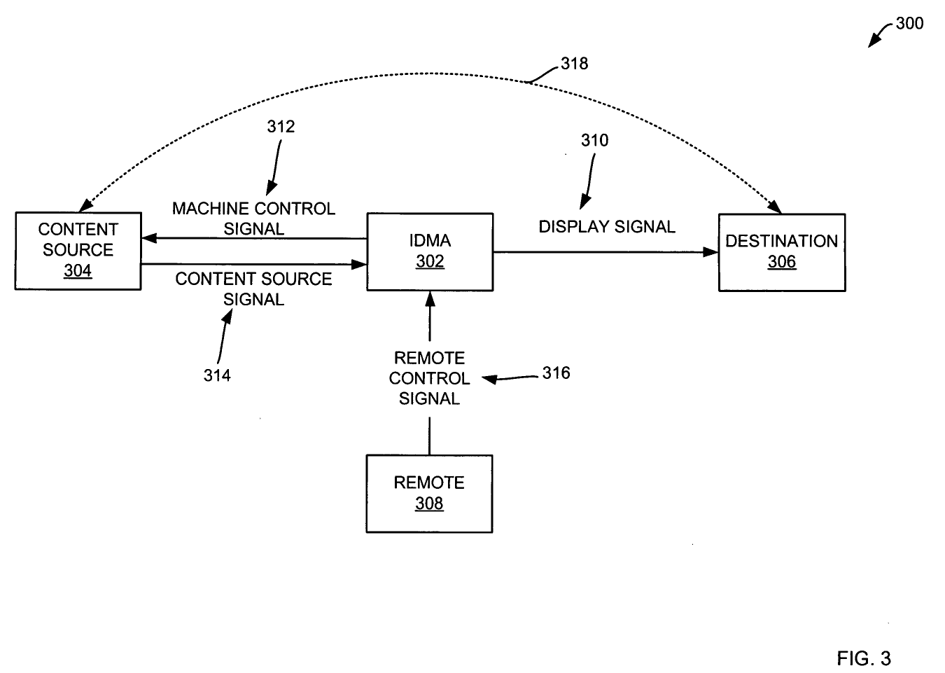

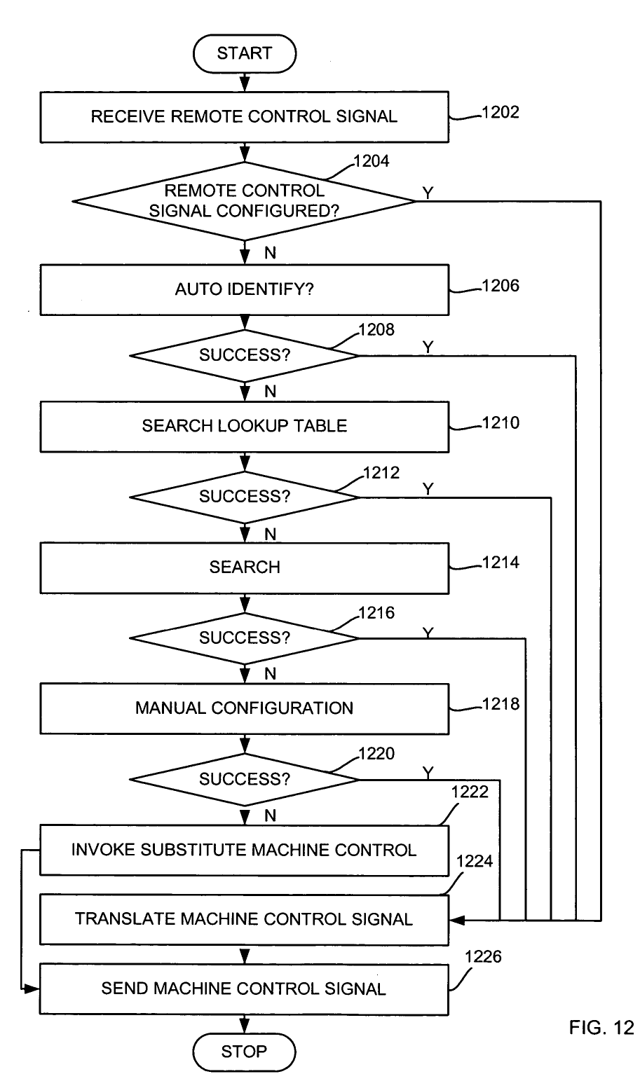

FIG. 3 is a diagrammatic representation of signal paths 300 in accordance with an embodiment of the present invention. A central component of the embodiment of FIG. 3 is intelligent data management arrangement (IDMA) 302. IDMA 302 serves to manage signals present in a content distribution system. Thus, IDMA 302 receives remote control signals 316 either locally or via remote 308 that may be configured utilizing a wired or wireless connection. Remote control signal 316 may include, in some examples, channel selection signals, display configuration signals, configuration input signals, content source control signals, and the like. As can be appreciated, wireless remote control signals may be transmitted in any manner well-known in the art. In some embodiments, a single, dedicated remote may be utilized. In other embodiments, any remote not normally configured for use with present embodiments may be utilized. Remote configuration will be discussed in further detail below for FIG. 12. At least one advantage contemplated by embodiments disclosed herein allows for the use of any remote control device not normally configured for use with a content distribution system to affect control over the content distribution system. Thus, a user need not be troubled with finding a remote configured to operate with a specific content source. Nor must a user configure a universal remote to “learn” commands for a specific content source. In some embodiments, an IDMA may be configured to “pass through” remote control signals of a remote control device to allow control of a selected content source. In still other embodiments, a simplified and dedicated remote control device may be utilized to control content sources.

IDMA 302 may also be configured to receive content source signal 314 from content source or content source component 304. Content sources may include for example: a cable receiver, a video cassette recorder/player (VCR), a digital video disk recorder/player (DVD), a satellite receiver, a personal video recorder/player (PVR), an antenna, a stereo system, a radio, a personal computer, a digital storage system, a compact disc player, an Internet connection, a network connection, a game console, a camera, a camcorder, a phone system, a television, a network storage device, an electronic storage device, and a projector, and any other source capable of delivering content. Thus, some embodiments may be configured to receive audio only signals, video only signals, audio and video signals, and data streams. Further, some embodiments may be configured to receive both analog and digital signals. Still further, some embodiments may be configured to receive both wired and wireless signals. As one can appreciate, any combination of the above embodiments may be employed without departing from the present invention. Further content source signal may be transmitted in any manner well known in the art.

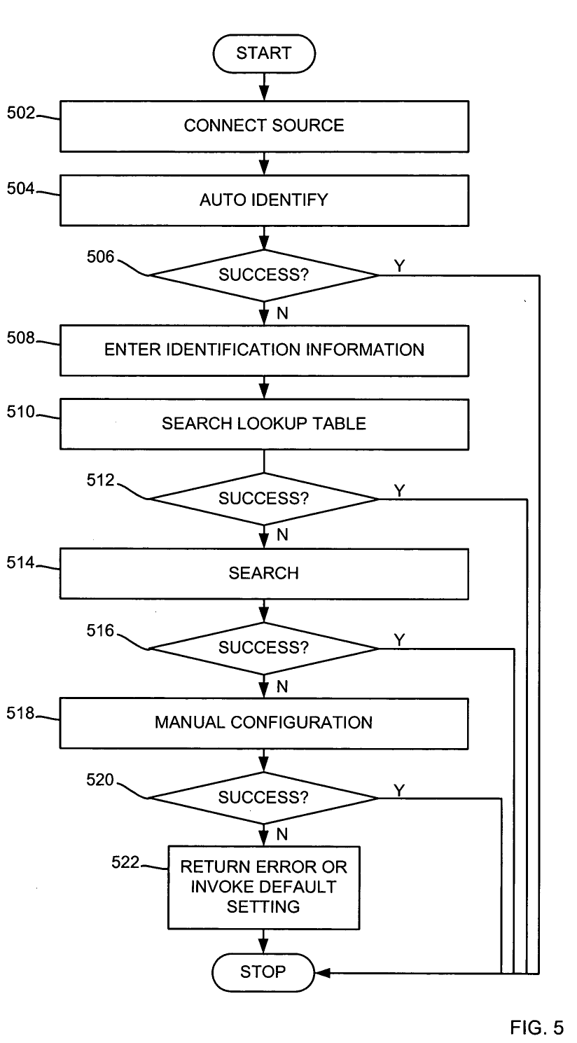

IDMA 302 may be further configured to send a machine control signal 312 to content source 304. IDMA 302 may manage any number of content sources for distribution to any number of displays in accordance with user preferences. Additionally, any number of IDMA's may be configured in a particular system without departing from the present invention. Machine control signal 312 is a signal which controls functionality of content source 304. Any number of content sources may be controlled independently or in parallel by IDMA 302. Configuration of IDMA 302 for use with a content source may be accomplished automatically or manually. Configuration of IDMA 302 for use with a content source will be discussed in further detail below for FIG. 5. In some embodiments, although a content source may not be readily configurable, IDMA 302 may “learn” to control a particular content source by asserting a substitute machine control, which may then be permanently associated with that content source if the substitute machine control is successful in controlling that content source. Substitute machine control will be discussed in further detail below for FIG. 12.

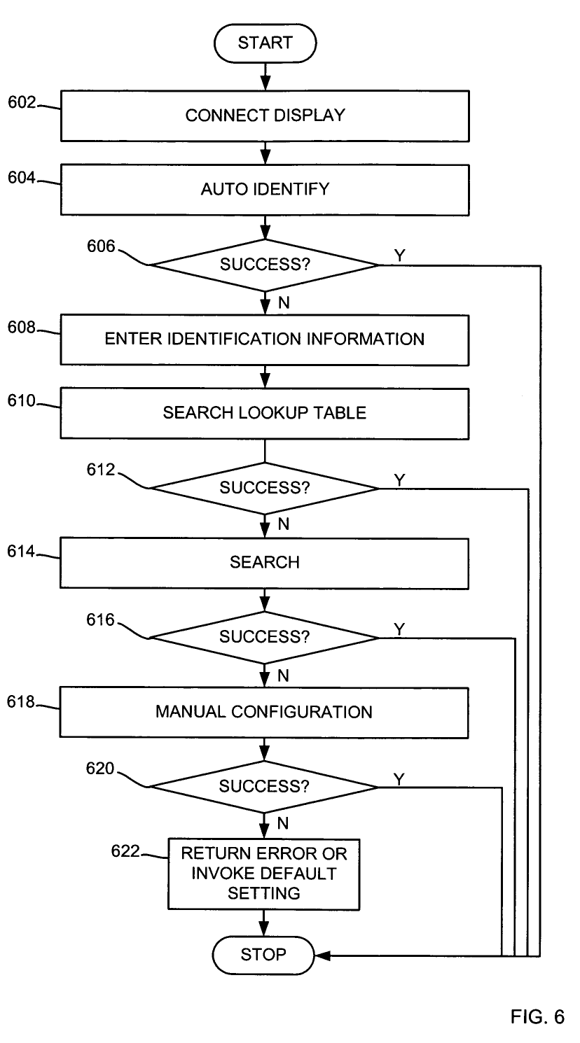

Finally, IDMA 302 may be configured to send display signal 310 to destination or destination component 306. In some embodiments, display signal 310 is simply source content signal 314 passed through IDMA 302. In other embodiments, display signal 310 may be altered to conform to destination 306 standards. For example, in an embodiment where destination 306 is a television and content source 304 is a personal computer, content source signal 314 may not match the resolution capability of a television for which the signal is intended. In that example, IDMA 302 may convert content source signal 314 to display signal 310 that is compatible with destination 306 (i.e. NTSC television) standards. Where a display is capable of displaying multiple formats, IDMA 302 may convert or pass through content source signal. IDMA configuration for use with a display will be discussed in further detail below for FIG. 6. It may be appreciated that there are many types of destinations. For example, a display is one type of destination that may receive a display signal. Other types of destinations are a storage device and a content source. Thus, a content source may serve dual functionality in some embodiments by providing a content signal and receiving a display signal. Further, a storage device may receive a display signal for storage, but may not be configured to display the display signal in some embodiments. It may further be appreciated that content source 304 and destination 306 may be functionally interrelated as indicated by line 318. That is, a content source may, in some embodiments, function as a display source as well. For example, a personal computer may be utilized as a content source as noted above. However, most personal computers also come equipped with a display that, when utilized with a properly configured IDMA, may be utilized to display content from other sources. Thus, the designation of content source or display is not intended to be limiting with respect to configurations contemplated by the present invention.

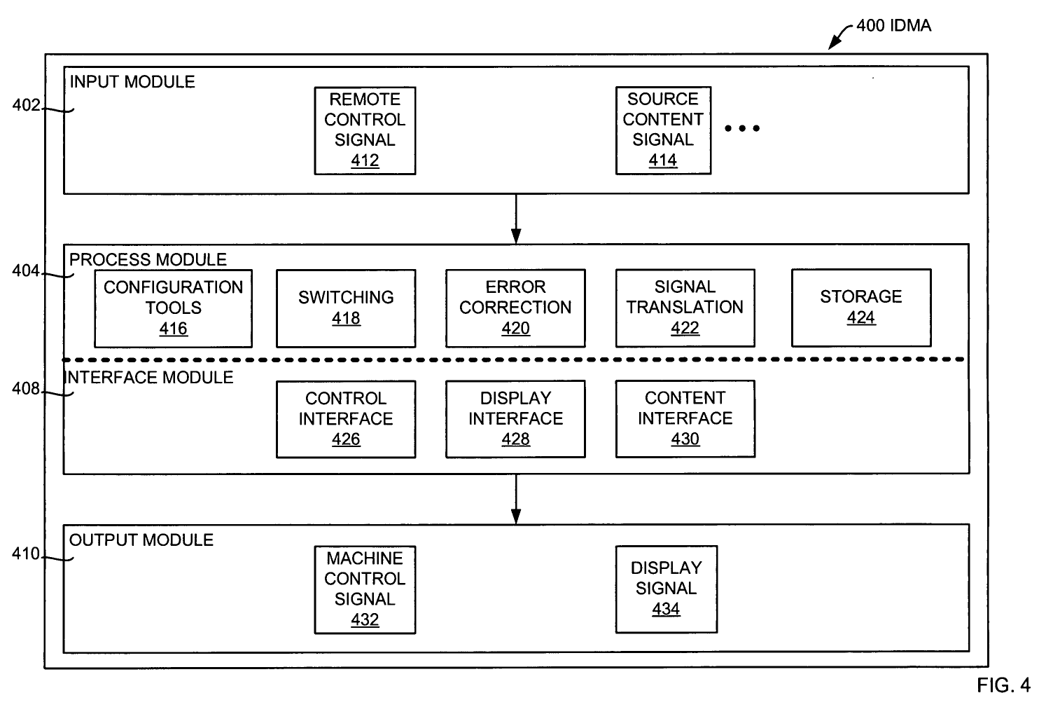

FIG.4 is a diagrammatic representation of a functional view of an IDMA 400 in accordance with an embodiment of the present invention. As illustrated, IDMA 400 may be functionally divided into four general functional modules: input module 402; process module 404; interface module 408; and output module 410. Each module may be further distinguished by particular functionality. Thus, a first module, input module 402, may be configured to receive remote control signal 412 and content source signal 414. As noted above, IDMA 400 may be configured to receive remote control signal 412 either locally or via remote utilizing a wired or wireless connection. Remote control signal 412 may include, in some embodiments, channel selection signals, display configuration signals, configuration input signals, content source control signals, and the like. As can be appreciated, wireless remote control signals may be transmitted in any manner well-known in the art. Also, as noted above, IDMA 400 may also be configured to receive content source signal 414 from one or more content sources. Content sources may include for example: a cable receiver, a video cassette recorder/player (VCR), a digital video disk recorder/player (DVD), a satellite receiver, a personal video recorder/player (PVR), an antenna, a stereo system, a radio, a personal computer, a digital storage system, a compact disc player, an Internet connection, a network connection, a game console, a camera, a camcorder, a phone system, a television, a network storage device, an electronic storage device, and a projector, and any other source capable of delivering content. Thus, some embodiments may be configured to receive audio only signals, video only signals, audio and video signals, and data streams. Further, some embodiments may be configured to receive both analog and digital signals. Still further, some embodiments may be configured to receive both wired and wireless signals. As one can appreciate, any combination of the above embodiments may be employed without departing from the present invention. Further, content source signal may be transmitted in any manner well known in the art.

A second module, process module 404 includes configuration tools component 416; switching component 418; error correction component 420; signal translation component 422; and storage component 424. Configuration will be discussed in further detail below for FIGS. 5 and 6. Switching component 418 includes processes by which signal streams are directed to a particular display. Switching is generally well known in the art. Error correction component 420 includes processes by which signal integrity may be preserved. In content distribution systems as described herein, signal transmission may be affected by any number of factors including for example, electromagnetic discharge events, dropped frames, or dropped packets. Error correction component 420 may be utilized to overcome in part or in whole factors which jeopardize signal transmission thus enhancing a user's viewing experience. Error correction is generally well known in the art.

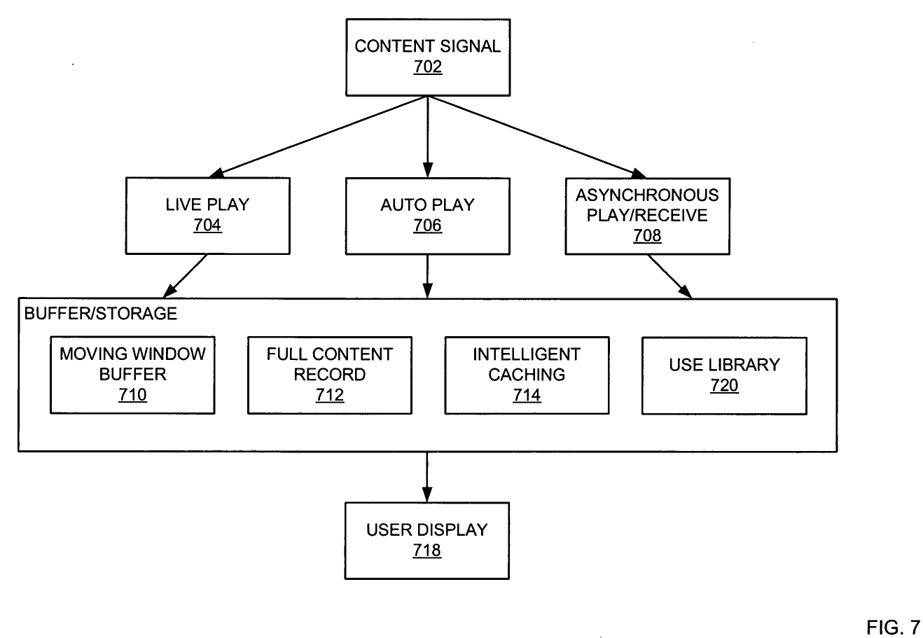

Signal translation component 422 includes processes by which a source content signal may be converted to a compatible display signal format. In some embodiments, display signal 434 is simply source content signal 414 passed through IDMA 400. In other embodiments, display signal 434 may be altered to conform to display standards. For example, in an embodiment where a display is a television and a content source is a personal computer, content source signal 414 may not match the resolution capability of a television for which the signal is intended. In that example, IDMA 400 may convert content source signal 414 to display signal 434 that is compatible with display (for example, NTSC television) standards. Where a display is capable of displaying multiple formats, IDMA 400 may convert or pass through content source signal 414. For example, a widescreen (i.e. 16×9) format may be automatically adjusted for display on a conventional 4×3 display. Signal translation component 422 may also include processes by which remote control signals are processed. Remote control signal processes are discussed in further detail below for FIG. 12. Finally, storage component 424 provides processes for buffering and storage of content in some embodiments of the present invention. Buffering and storage will be discussed in further detail below for FIG. 7

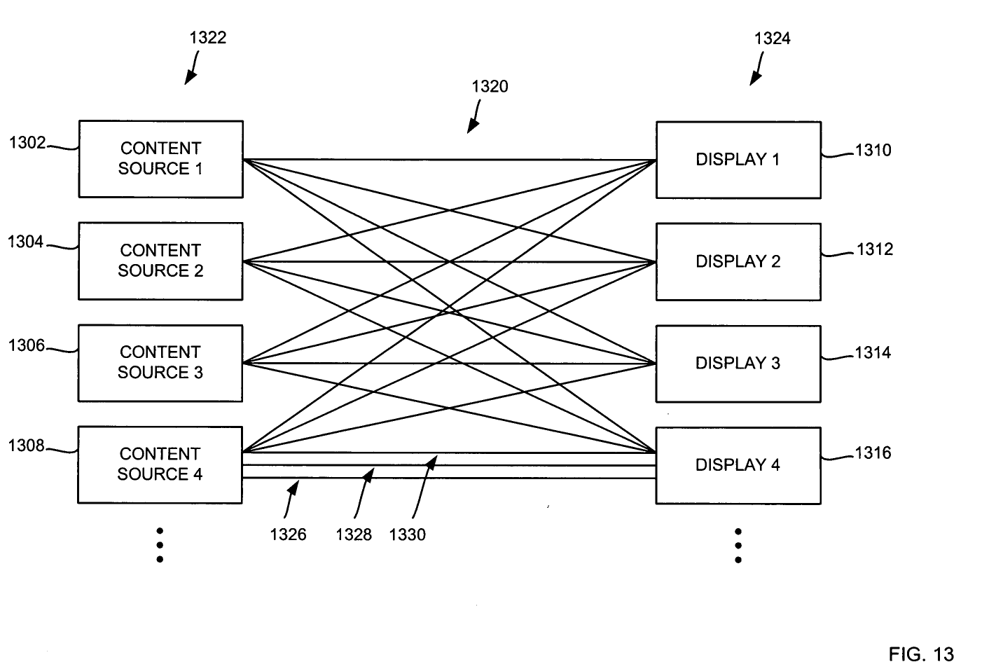

A third module, interface module 408 includes control interface 426, display interface 428, and content interface 430. Control interface 426 may be configured to process communication between IDMA 400 and content sources and to provide a user interface for controlling content sources and remote control devices. Control interface 426 may be implemented in hardware, software, or both without departing from the present invention. Display interface 428 may be configured to process communication between IDMA 400 and a display and to provide a user interface for controlling a display. In some embodiments, display interface signals may include a menu signal as managed by content interface for use in configuring devices described herein. In other embodiments, display interface may contain user interfaces that may include a system update for determining status of a content distribution system. Content interface 430 may be configured to process content signals including access controls and buffering and storage controls. Access control will be discussed in further detail below for FIG. 13. Buffering and storage control will be discussed in further detail below for FIG. 7.

A fourth module, output module 410, includes machine control signal 432 and display signal 434. As noted above, machine control signal 432 is a signal which controls functionality of a content source. Any number of content sources may be controlled independently or in parallel by IDMA 400. Configuration of IDMA 400 for use with a content source may be accomplished automatically or manually. Content source configuration will be discussed in further detail below for FIG. 5. In some embodiments, although a content source may not be readily configurable, IDMA 400 may “learn” to control a particular content source by asserting a substitute machine control, which may then be permanently associated with that content source if the substitute machine control is successful in controlling that content source. Substitute machine control will be discussed in further detail below for FIG. 12.

Further, as noted above, IDMA 400 may be configured to send a display signal 434 to a display. In some embodiments, display signal 434 is simply source content signal 414 passed through IDMA 302. In other embodiments, display signal 414 may be altered to conform to a particular display standard. In still other embodiments, the IDMA may be configured to compress and decompress a content signal. For example, in an embodiment where the display is a television and the content source is a personal computer, content source signal 414 may not match the resolution capability of the television for which the signal is intended. In that example, IDMA 400 may convert content source signal 414 to display signal 434 that is compatible with display (for example, NTSC television) standards. Where a display is capable of displaying multiple formats, IDMA 400 may convert or pass through content source signal. For example, a widescreen (i.e. 16×9) format may be automatically adjusted for display on a conventional 4×3 display. IDMA configuration for use with a display will be discussed in further detail below for FIG. 6.

As noted above, embodiments of the present invention include several configuration methods. FIG. 5 is a diagrammatic flowchart of a method of configuring an IDMA for use with a content source in accordance with an embodiment of the present invention. At a first step 502, a content source is electronically connected with the IDMA. As can be appreciated, an electronic connection may be either wired, or wireless in accordance with device configurations. As noted above, any number of content sources may be utilized under the present invention for example: a cable receiver, a video cassette recorder/player (VCR), a digital video disk recorder/player (DVD), a satellite receiver, a personal video recorder/player (PVR), an antenna, a stereo system, a radio, a personal computer, a digital storage system, a compact disc player, an Internet connection, a network connection, a game console, a camera, a camcorder, a phone system, a television, a network storage device, an electronic storage device, and a projector, and any other source capable of delivering content. Because of the wide range and variety of content sources available to a user, a method of easily configuring an IDMA for use with a content source may be desirable. Thus, at a step 504, the method attempts to auto-identify a connected content source for plug and play operability. In those examples, an IDMA may communicate with a content source using a standard plug and play protocols in order to configure the IDMA. In some embodiments, an IDMA may be configured for use with a non-standard plug and play protocol for communicating with a content source. In other embodiments, an IDMA may be configured for use with a newly defined standard protocol. In still other embodiments, an IDMA may be configured for use with a combination of non-standard and standard plug and play protocols for communicating with a content source. Plug and play protocols are generally well known in the art. If the content source is able to communicate automatically with an IDMA, then the method configures the IDMA and returns a success at a step 506 whereupon the method ends.

If the content source is unable to communicate automatically with an IDMA, the method continues to a step 508 where a user may enter identification information into the IDMA. Identification information may include, for example, make and model information corresponding to a connected content source. In some embodiments, identification information may be obtained from a bar code. Once a user has entered identification information, the method searches a lookup table, at a step 510, for configuration information corresponding to a connected content source. If configuration information corresponding to a connected content source is available in a lookup table, then the method configures the IDMA and returns a success at a step 512 whereupon the method ends.

If no configuration information is found, the method continues to search for configuration information at a step 514. As can be appreciated, searching may be local including local drives and memory. Searching may also be extended network wide and Internet wide in accordance with user preferences. In some examples, an IDMA may search a manufacturer support site and return a configuration file. If searching yields configuration information corresponding to a connected content source, the method configures the IDMA and returns a success at a step 516 whereupon the method ends.

If no configuration is found, the method continues to prompt a user for manual configuration information at a step 518. In manually configuring an IDMA in one embodiment, a user may assign machine controls from a list of generic commands. For example, a list may include several play commands from various manufacturers. A user would select a command, invoke the selected command, and then monitor the content source to determine whether a selected command properly controlled the content source. Any number of commands may be selected in accordance with the content source's configuration. In another embodiment, a user may select from a set of default commands for a source device. Default commands may be available in addition to commands found in a lookup table as in at a step 510. In still other embodiments, an IDMA may be manually configured by entering a manufacturing code corresponding to a remote control command. Thus, in some embodiments, where a manufacturer code is available, a user may simply select a manufacturer code corresponding to an appropriate command which may be configured into an IDMA. In still other embodiments, an IDMA may “learn” commands from a remote device. That is, a remote device command may be sent to an IDMA whereupon a user may select an appropriate corresponding command from a list, for example. In this manner, a set of commands for a given device may be “learned” by an IDMA. If a content source may be configured manually, the method returns a success at a step 520 whereupon the method ends. If the content source cannot be configured, the method returns an error or invokes a default setting in accordance with user preferences at a step 522 whereupon the method ends. As can be appreciated, default settings may be configured in any number of manners. For example, default settings may be pre-configured “out of the box” such that a user need not select a particular default. In other examples, a selection of default settings may be presented to a user for selection. In still other examples, a content source's remote control operations may be automatically configured when the content source is configured. Further configuration operations for a remote are discussed in further detail below for FIG. 12.

Another configuration method is illustrated by FIG. 6. FIG. 6 is a diagrammatic flowchart of a method of configuring an IDMA for use with a display in accordance with an embodiment of the present invention. As can be appreciated, the method described in FIG. 6 for configuring an IDMA is similar to methods described for FIG. 5. At a first step 602, a display is electronically connected with the IDMA. As can be appreciated, an electronic connection may be either wired, or wireless in accordance with user configurations. Any number of displays may be utilized under the present invention for example: a television display, a high definition display, an LCD display, a computer display, and a projection display. Because of the wide range and variety of displays available to a user, a method of easily configuring an IDMA for use with a display may be desirable. Thus, at a step 604, the method attempts to auto-identify a connected display. As can be appreciated, some displays may be configured for plug and play operability. In those examples, an IDMA may communicate with a display using a standard plug and play protocols in order to configure an IDMA. Plug and play protocols are generally well known in the art. If the display is able to communicate automatically with an IDMA, then the method configures the IDMA and returns a success at a step 606 whereupon the method ends.

If the display is unable to communicate automatically with an IDMA, the method continues to a step 608 where a user may enter identification information into the IDMA. Identification information may include, for example, make and model information corresponding to a connected display. In some embodiments, identification information may be obtained from a bar code. Once a user has entered identification information, the method searches a lookup table, at a step 610, for configuration information corresponding to a connected display. If configuration information corresponding to a connected display is available in a lookup table, then the method configures the IDMA and returns a success at a step 612 whereupon the method ends.

If no configuration information is found, the method continues to search for configuration information at a step 614. As can be appreciated, searching may be local including local drives and memory. Searching may also be extended network wide and Internet wide in accordance with user preferences. In some examples, an IDMA may search a manufacturer support site and return a configuration file. If searching yields configuration information corresponding to a connected display, the method configures the IDMA and returns a success at a step 616 whereupon the method ends.

If no configuration is found, the method continues to prompt a user for manual configuration information at a step 618. In manually configuring an IDMA, a user may assign display controls from a list of generic commands. For example, in one embodiment, a list may include several display commands from various manufacturers. A user would select a command, invoke the selected command, and then monitor a display to determine whether a selected command properly controlled the display. Any number of commands may be selected in accordance with the display's configuration. In another embodiment, a user may select commands from a set of pre-configured default settings by manufacturer or by type. If a display may be configured manually, the method returns a success at a step 620 whereupon the method ends. If the display cannot be configured, the method returns an error or invokes a default setting in accordance with user preferences at a step 622 whereupon the method ends. As can be appreciated, default settings may be configured in any number of manners. For example, default settings may be pre-configured “out of the box” such that a user need not select a particular default. In other examples, a selection of default settings may be presented to a user for selection.

FIG. 7 is a diagrammatic representation of signal paths of a content signal 702 in accordance with embodiments of the present invention. A user's viewing experience may, in some examples, be enhanced by managing content signal delivery. As can be appreciated, viewing delays may be introduced in transitioning between content sources due to any number of factors including, for example, digital and analog timing factors, source “spin up” factors, and satellite tracking factors. Managing content signal delivery may reduce or eliminate at least some of these factors. Thus, in embodiments of the present invention, content signal 702 may be delivered in any of three play modalities: live play 704, auto play 706; or asynchronous play 708.

Live play 704 refers to a content signal that is played simultaneously with a user request. That is, in some embodiments, a user may make a content selection whereupon corresponding content signal 702 is immediately delivered to an IDMA. Auto play 706 refers to a content signal that is configured to be delivered to an IDMA automatically in accordance with user preferences. That is, in some embodiments, a user may make a selection for content that will occur in the future. That content signal may then be viewed either when the signal arrives, or in some embodiments, when a user desires. As can be appreciated, content signals may be sent at a rate equal to a corresponding play rate, or may be sent at a different rate (i.e. either higher or lower) than a corresponding play rate in accordance with user preferences. In other embodiments, auto play 706 may refer to a player source device, such as a VCR. In that example, content signal may be auto played when a tape is inserted into a player source device or at a time selected by a user. In other embodiments, a source device may auto send content when content is received or when a timing event has occurred. In still other embodiments, an IDMA may automatically request content from a source device. Asynchronous play/receive 708 refers to a content signal that is loaded to an IDMA independently of its play speed. For example, a 60 minute program may be completely loaded to an IDMA in as little as a few minutes or seconds. Loading (or viewing) a program may offer advantages in managing content sources since once a program is loaded, control of a particular content source may be freed for other uses. At least one advantage of receiving content at a rate that differs from a play rate is that error correction may be incorporated in advance of play rates. Another advantage is that viewing habits may be monitored in advance of actual viewing thus providing distribution intelligence for future viewing. In some embodiments, content may be received from multiple sources sending parallel data. In another embodiment of asynchronous play, an IDMA may be configured to continue receiving content while a display is occupied with other user requests. For example, a user could execute display controls such as pause, fast forward, rewind, and the like while an IDMA continues to receive source content.

Each of the three delivery methods described above (i.e. live play 704, auto play 706, and asynchronous play 708) may be buffered or stored in any of three different ways: moving window buffer 710, full content record 712, or intelligent caching 714. In other words, content may be automatically recorded using any of the above methods singly or in combination without departing from the present invention. Thus, for example, live play 704 content signal may be configured for a moving window buffer 710. A moving window buffer stores a content signal for a fixed interval that continuously changes with respect to play time. In the example given, live play 704 may be configured for a 30 minute moving window buffer. Therefore, if a live play 704 content signal is selected at 5:00, then an IDMA buffers that live play 704 content signal for 30 minutes until 5:30 (5:00-5:30). At 5:31, the buffer window moves forward to 5:01 thus preserving the 30 minute moving window buffer. Buffering, in this manner, allows a user to rewind portions of a program within the moving window buffer. As can be appreciated, size of the moving window buffer is variable and may be made in accordance with user preferences and hardware requirements.

A second storage method is full content record 712. Full content record 712 may be manually configured or automatically configured utilizing a published viewing guide. Full content record 712 may store an entire program of content signal from a content source. In some examples, full content record 712 may utilize a viewing guide to determine start and stop times. In other examples, a user may manually enter a start and stop time. Full content record 712 allows a user to review any portion of a stored program. Full content record 712 may be utilized in accordance with user preferences and hardware requirements.

A third storage method is intelligent caching 714. Intelligent caching 714 may be used to cache content of interest to a user. For example, if a user utilizes a DVD carousel that is capable of holding five disks, intelligent caching 714 may cache an interval from each disk so that when a disk is selected, display may begin immediately while the selected disk is prepared for play. Additionally, a user may continue to switch disks while preserving stop points in previously viewed disks, as well as preserving the current and a next segment of the disk. In this manner, a user's viewing experienced may be enhanced by reducing “spin-up’ lag common in prior art systems. As can be appreciated intelligent caching 714 may utilized with a variety of content sources without departing from the present invention. For example, in one embodiment, for content sources capable of delivering multiple channels of cable, intelligent caching may preserve a portion of each delivered channel as selected by a user. In another embodiment, frequently used content and menus may be cached so that a user may efficiently access desired programming material. Once content signal 702 has been processed, the signal may be displayed on user display 718.

In addition to embodiments described for signal paths of a content signal, auto-polling of a content signal may also be accomplished. Auto-polling allows a user to request content identification that may be resident in a distribution system at any given time. Thus, an IDMA may return, in response to a user request, all content buffered or stored on a system. By periodically refreshing identification information, a user may more effectively manage content assets and monitor content usage. In some embodiments, a use library 720 may be stored in cooperation with auto-polling. A use library may store any number of user defined parameters including information corresponding to: content sent to a display; content available for viewing; displays available for use; and the like. In some embodiments, content sources having storage capability may be utilized by an IDMA. In other embodiments, an IDMA may automatically poll content sources without user input. That is, polling content sources may be configured to respond to user selections of content rather than by a user specified criteria. Polling may continue during viewing and non-viewing periods without limitation.

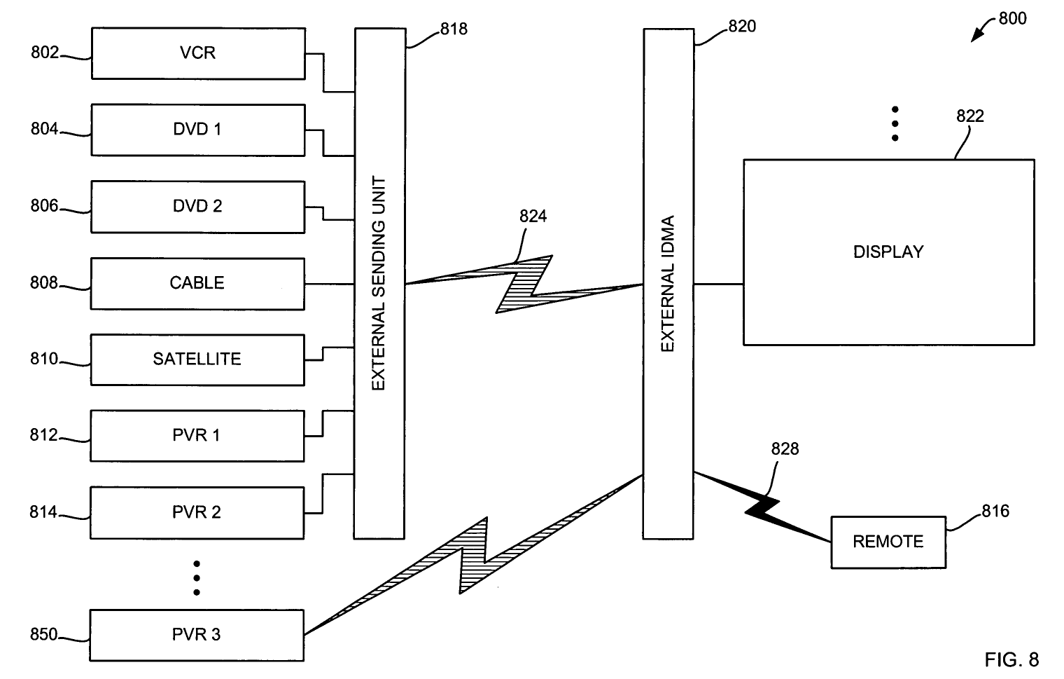

FIG. 8 represents an embodiment of the present invention intended to accommodate legacy content distribution systems. That is, where selected component are not internally configured according to embodiments of the present invention, external configurations may be provided. In the embodiment illustrated, a number of content sources 802-814 may be provided. Content sources may include for example: a cable receiver 808, a video cassette recorder/player (VCR) 802, a digital video disk recorder/player (DVD) 804-806, a satellite receiver 810, a personal video recorder/player (PVR) 812-814, an antenna (not shown), a stereo system (not shown), a radio (not shown), a personal computer (not shown), a digital storage system (not shown), a compact disc player (not shown), an Internet connection (not shown), a network connection (not shown), a game console (not shown), a camera (not shown), a camcorder (not shown), a phone system (not shown), a television (not shown), a network storage device (not shown), an electronic storage device (not shown), a projector (not shown), and any other source capable of delivering content. Thus, some embodiments may be configured to receive audio only signals, video only signals, audio and video signals, and data streams. Further, some embodiments may be configured to receive both analog and digital signals. Still further, some embodiments may be configured to receive both wired and wireless signals. As one can appreciate, any combination of the above embodiments may be employed without departing from the present invention.

As noted above, in some configurations, a number of content sources can result in excessive cabling requirements. Thus, external sending unit 818 may be provided. External sending units may be provided to support legacy devices that do not have the sending unit function already built-in to the device. As such, external sending units provide a means to leverage existing devices for use with an IDMA enabled system. External sending unit 818 may be configured to send content signal to external IDMA 820. External sending unit 818 allows a number of content sources to be centrally located, thus providing for ease of installation, service, and access. External sending unit 818 may communicate with external IDMA 820 through wired or wireless connection 824. As can be appreciated, any number of wireless protocols may be utilized in accordance with user preferences without departing from the present invention. Furthermore, external sending unit 818 and IDMA 820 may share some or all functionality. For example, external sending unit 818 may, in some embodiments, be configured with storage capability as noted above. Still further, external sending unit 818 may be configured to receive remote control signals. Still further, external sending unit 818 and external IDMA 820 may be configured to compress and decompress content signals. As can be appreciated, functionality between external sending unit 818 and IDMA 820 may be configured in combination without limitation.

External sending unit 818 may be further configured to receive machine control signals from external IDMA 820. Machine control signals are signals which control functionality of content sources 802-814. Thus, in some embodiments, each content source 802-814 may be controlled independently or in parallel by external IDMA 820. Configuration of an IDMA for use with a content source is discussed in further detail above for FIG. 5. A user may input commands to external IDMA 820 either locally, or remotely 816 through wired or wireless connection 828. In some embodiments, remote 816 may be configured to control more than one content source at a time. Thus, multiple content sources may be operated simultaneously. External IDMA 820 is also configured to send display signal to display 822.

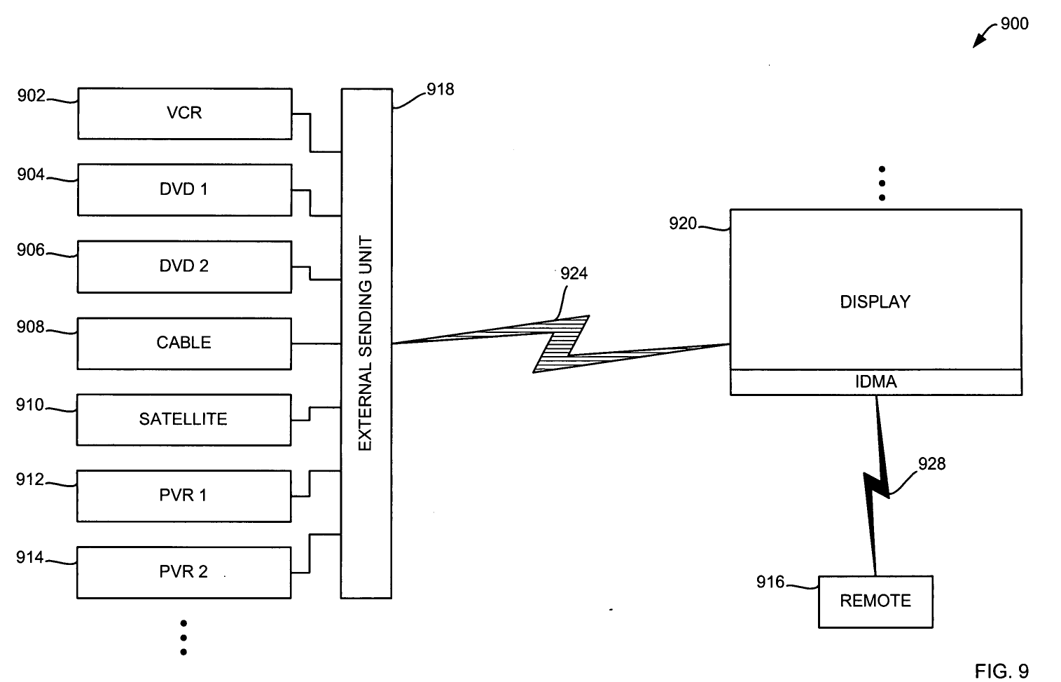

FIG. 9 represents an embodiment of the present invention intended to accommodate legacy content distribution systems. That is, where selected components are not internally configured according to embodiments of the present invention, external configurations may be provided. In the example embodiment illustrated, a number of content sources 902-914 may be provided. Content sources may include for example: a cable receiver 908, a video cassette recorder/player (VCR) 902, a digital video disk recorder/player (DVD) 904-906, a satellite receiver 910, a personal video recorder/player (PVR) 912-914, an antenna (not shown), a stereo system (not shown), a radio (not shown), a personal computer (not shown), a digital storage system (not shown), a compact disc player (not shown), an Internet connection (not shown), a network connection (not shown), a game console (not shown), a camera (not shown), a camcorder (not shown), a phone system (not shown), a television (not shown), a network storage device (not shown), an electronic storage device (not shown), a projector (not shown), and any other source capable of delivering content. Thus, some embodiments may be configured to receive audio only signals, video only signals, audio and video signals, and data streams. Further, some embodiments may be configured to receive both analog and digital signals. Still further, some embodiments may be configured to receive both wired and wireless signals. As one can appreciate, any combination of the above embodiments may be employed without departing from the present invention.

As noted above, in some configurations, a number of content sources can result in excessive cabling requirements. Thus, external sending unit 918 may be provided. As noted above, external sending units may be provided to support legacy devices that do not have the sending unit function already built-in to the device. As such, external sending units provide a means to leverage existing devices for use with an IDMA enabled system. External sending unit 918 may be configured to send content signal to display/IDMA 920. External sending unit 918 allows a number of content sources to be centrally located, thus providing for ease of installation, service, and access. External sending unit 918 may communicate with display/IDMA 920 through wired or wireless connection 924. Still further, external sending unit 918 and IDMA 920 may be configured to compress and decompress content signals. As can be appreciated, any number of wireless protocols may be utilized in accordance with user preferences without departing from the present invention.

External sending unit 918 may be further configured to receive machine control signal from display/IDMA 920. Machine control signals are signals which control functionality of content sources 902-914. Thus, in some embodiments, each content source 902-914 may be controlled independently or in parallel by display/IDMA 920. Configuration of an IDMA for use with a content source is discussed in further detail above for FIG. 5. A user may input commands to display/IDMA 920 either locally, or remotely 916 through wired or wireless connection 928. In some embodiments, remote 916 may be configured to control more than one content source at a time. Thus, multiple content sources may be operated simultaneously.

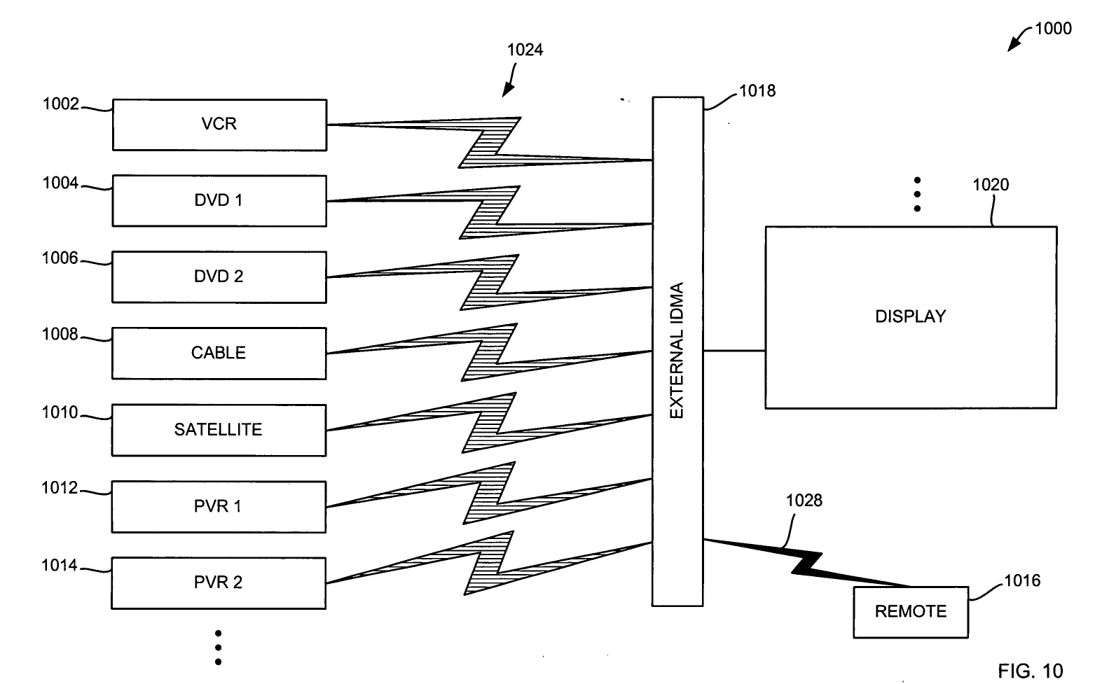

FIG. 10 represents an embodiment of the present invention intended to accommodate legacy content distribution systems. That is, where selected component are not internally configured according to embodiments of the present invention, external configurations may be provided. In the example embodiment illustrated, a number of content sources 1002-1014 may be provided. Content sources may include for example: a cable receiver 1008, a video cassette recorder/player (VCR) 1002, a digital video disk recorder/player (DVD) 1004-1006, a satellite receiver 1010, a personal video recorder/player (PVR) 1012-1014, an antenna (not shown), a stereo system (not shown), a radio (not shown), a personal computer (not shown), a digital storage system (not shown), a compact disc player (not shown), an Internet connection (not shown), a network connection (not shown), a game console (not shown), a camera (not shown), a camcorder (not shown), a phone system (not shown), a television (not shown), a network storage device (not shown), an electronic storage device (not shown), a projector (not shown), and any other source capable of delivering content. Thus, some embodiments may be configured to receive audio only signals, video only signals, audio and video signals, and data streams. Further, some embodiments may be configured to receive both analog and digital signals. Still further, some embodiments may be configured to receive both wired and wireless signals. As one can appreciate, any combination of the above embodiments may be employed without departing from the present invention.

As noted above, in some configurations, a number of content sources can result in excessive cabling requirements. Thus, internally integrated sending units for each content source may be provided. Internally integrated sending units may be configured to send content signal to external IDMA 1018. Internally integrated sending units allow a number of content sources to be centrally located, thus providing for ease of installation, service, and access. Internally integrated sending units may communicate with external IDMA 1018 through wired or wireless connections 1024. Still further, sending units and external IDMA 1018 may be configured to compress and decompress content signals. As can be appreciated, any number of wireless protocols may be utilized in accordance with user preferences without departing from the present invention.

Internally integrated sending units may be further configured to receive machine control signal from external IDMA 1018. Machine control signals are signals which control functionality of content sources 1002-1014. Thus, in some embodiments, each content source 1002-1014 may be controlled independently or in parallel by external IDMA 1018. Configuration of an IDMA for use with a content source is discussed in further detail above for FIG. 5. A user may input commands to external IDMA 1018 either locally, or remotely 1016 through wired or wireless connection 1028. In some embodiments, remote 1016 may be configured to control more than one content source at a time. Thus, multiple content sources may be operated simultaneously. External IDMA 1018 is also configured to send display signal to display 1020.

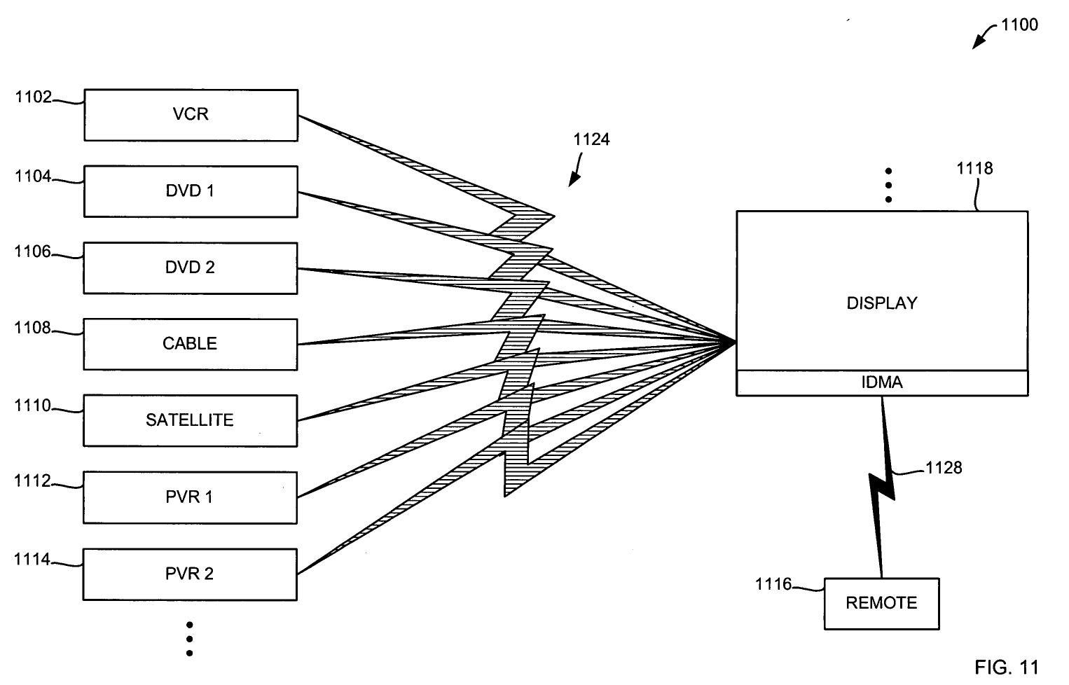

FIG. 11 is a diagrammatic representation of an integrated system overview 600 in accordance with an embodiment of the present invention. In the example embodiment illustrated, a number of content sources 1102-1114 may be provided. Content sources may include for example: a cable receiver 1108, a video cassette recorder/player (VCR) 1102, a digital video disk recorder/player (DVD) 1104-1106, a satellite receiver 1110, a personal video recorder/player (PVR) 1112-1114, an antenna (not shown), a stereo system (not shown), a radio (not shown), a personal computer (not shown), a digital storage system (not shown), a compact disc player (not shown), an Internet connection (not shown), a network connection (not shown), a game console (not shown), a camera (not shown), a camcorder (not shown), a phone system (not shown), a television (not shown), a network storage device (not shown), an electronic storage device (not shown), a projector (not shown), and any other source capable of delivering content. Thus, some embodiments may be configured to receive audio only signals, video only signals, audio and video signals, and data streams. Further, some embodiments may be configured to receive both analog and digital signals. Still further, some embodiments may be configured to receive both wired and wireless signals. As one can appreciate, any combination of the above embodiments may be employed without departing from the present invention.

As noted above, in some configurations, a number of content sources can result in excessive cabling requirements. Thus, internally integrated sending units for each content source may be provided. Internally integrated sending units may be configured to send content signal to display/IDMA 1118. Internally integrated sending units allow a number of content sources to be centrally located, thus providing for ease of installation, service, and access. Internally integrated sending units may communicate with display/IDMA 1118 through wired or wireless connections 1124. Still further, sending units and display/IDMA 1118 may be configured to compress and decompress content signals. As can be appreciated, any number of wireless protocols may be utilized in accordance with user preferences without departing from the present invention.

Internally integrated sending units may be further configured to receive machine control signal from display/IDMA 1118. Machine control signals are signals which control functionality of content sources 1102-1114. Thus, in some embodiments, each content source 1102-1114 may be controlled independently or in parallel by display/IDMA 1118. Configuration of an IDMA for use with a content source is discussed in further detail above for FIG. 5. A user may input commands to display/IDMA 1118 either locally, or remotely 1116 through wired or wireless connection 1128. In some embodiments, remote 1116 may be configured to control more than one content source at a time. Thus, multiple content sources may be operated simultaneously. As can be appreciated, embodiments described in FIGS. 8-11 may include combinations of legacy and integrated systems without limitation. Although the embodiments illustrated show specific configurations, other combinations of configurations may be utilized without departing from the present invention. Thus, for example, the system as described in FIG. 8 may be combined with a partially integrated system as illustrated in FIGS. 9 and 10 or with fully integrated systems as illustrated in FIG. 11.

FIG. 12 is a diagrammatic flowchart of a method of processing a remote control signal in accordance with an embodiment of the present invention. At a first step 1202, an IDMA receives a remote control signal. A remote control signal may be sent wired or wirelessly. A remote control signal typically includes selection and configuration commands that may be nested in menus or other graphical user interfaces. In one embodiment, a simplified remote control device may be configured to send uniform remote control commands signals to an IDMA independent of a content source or display device being controlled. The device to be controlled may be selected by any means such as by a menu selection or by a key or button. Thus, for example, a play command sent by a simplified remote control device sends the same remote control signal (i.e. play command) to an IDMA independent of whether a user is currently controlling a TV, a projector, a DVD player, or any other content source. An IDMA functions to translate the remote control signal to an appropriate command corresponding to the content source or display device being controlled. An IDMA, as noted above, may be configured automatically, manually, or by default configurations with the appropriate information to support the remote control signal translation to any or all devices. In this embodiment, the IDMA may be conceptualized as a “universal remote controller” able to control any connected device with the same simplified remote control device. The remote control device can enjoy a smaller profile and be configured with a simplifier control layout as compared to the larger, more complex universal remotes in use today. In some embodiments, the remote control device may contain the additional ability to provide traditional “universal remote” capabilities for multiple devices through menus or overlays.

In other embodiments a remote control signal may originate from any of a variety of sources such that an IDMA may be considered a universal remote control receiving system as well. In some embodiments, an IDMA may be configured to “pass through” remote control signals of a remote control device to allow control of a selected content source. The method then determines whether a remote control signal has been previously configured at a step 1204. In some embodiments, a remote control signal is “passed through” an IDMA directly to a content source. Thus, an IDMA may either translate a configured remote control signal for use in controlling a content source or simply direct a remote control signal to a content source for direct control. As can be appreciated, flexible remote control as described herein may provide for source devices to be co-located in the same room, or in different rooms without sacrificing user control. Thus, a user may view content in one room while controlling content source located in another room. If the method determines that a remote control signal has been previously configured, the method continues to translate a remote control signal to a machine control signal at a step 1224 whereupon the method sends the machine control signal at a step 1226.

If the remote control signal has not been previously configured, the method continues to auto identify the remote control signal at a step 1206. As noted above, many devices are configured for plug and play operability. In those examples, an IDMA may communicate with a device (i.e. a remote control device) using standard plug and play protocols in order to configure the IDMA. Plug and play protocols are generally well known in the art. If the method successfully auto identifies a remote control signal at a step 1208, the method continues to translate a remote control signal to a machine control signal at a step 1224 whereupon the method sends the machine control signal at a step 1226.

If the method cannot auto identify the remote control signal, the method continues to search a look up table based on identification information corresponding to the remote control device entered by a user in order to identify the remote control signal at a step 1210. Identification information may include, for example, make and model information corresponding to a connected content source. An IDMA may come configured with any number of configuration parameters and look up tables. These tables may be searched in an attempt to identify a remote control signal. Look up tables are generally well known in the art. If the method successfully identifies a remote control signal from a look up table at a step 1212, the method continues to translate a remote control signal to a machine control signal at a step 1224 whereupon the method sends the machine control signal at a step 1226. As noted above, in some embodiments, a remote control signal is “passed through” an IDMA directly to a content source. Thus, an IDMU may either translate a configured remote control signal for use in controlling a content source or simply direct a remote control signal to a content source for direct control.

If the method cannot identify a remote control signal from a look up table, the method continues to search locally and remotely in order to identify the remote control signal at a step 1214. As noted above, an IDMA may, in some embodiments, search a local network or the Internet for configuration information. In some embodiments, an IDMA may search a specific manufacturing site for configuration parameters. If the method successfully identifies a remote control signal by searching at a step 1216, the method continues to translate a remote control signal to a machine control signal at a step 1224 whereupon the method sends the machine control signal at a step 1226.

If the method cannot identify a remote control signal by searching, the method continues to manually identify the remote control signal at a step 1218. Manual identification may take several forms. In one embodiment, a user may initiate a command whereupon the method will present a variety of known commands that may be associated with the initiated command. A user may then select an appropriate command whereupon the method will associate the initiated command with the selected command and store the results in a look up table, for example. If the method successfully identifies a remote control signal manually at a step 1220, the method continues to translate a remote control signal to a machine control signal at a step 1224 whereupon the method sends the machine control signal at a step 1226. In another embodiment, a user may select a screen command from a list of commands and then direct a remote control signal toward an IDMA whereupon the IDMA may associate the remote control signal with the selected screen command thereby “learning” the remote control signal.

If the method cannot identify a remote control signal manually, the method continues to invoke a substitute machine control for the remote control signal at a step 1222. In some embodiments, an IDMA may select a substitute machine control for a given user control. Because user controls are necessarily limited, many remote control signals may be similar. Similar control signals may present opportunities for an IDMA to “guess” at an expected command. A user may then confirm or reject a substitute machine control whereupon the method will either affirmatively or negatively associate the user command with the substitute machine control command and store the results in a look up table, for example. After the method invokes a substitute machine control at a step 1222, the method continues to send the machine control signal at a step 1226 whereupon the method then ends.

FIG. 13 is a diagrammatic representation of access control configurations in accordance with an embodiment of the present invention. As can be appreciated, any number of access control configurations may contemplated under the present invention. For example, source component 1322 which may comprise of any number of content sources 1302-1308 which may be connected with display component 1324 which may comprise any number of display devices 1310-1316 via connections 1320. In the illustrated example, 16 possible connections exist between source component 1322 and display component 1324. Still more connections may be contemplated for recording between source component 1355 and between display component 1324. Even so, a user may desire to limit access to certain content that may be considered objectionable by some users while preserving connectivity between components. For example, a user may desire to limit display in a common area to non-objectionable content during daytime and early evening hours while allowing unlimited viewer access to content during late night hours when a common area may have limited occupancy.

Access, therefore, may be limited in any of several ways. First, objectionable content (or content signals) may be blocked at content sources 1302-1308. Thus, a content source may be may be blocked from receiving content by a content control component where access authorization is denied. Second, objectionable content (or content signals) may be blocked from leaving content sources 1302-1308. Thus, a content source may be blocked from sending content by a content control component where access authorization is denied. Third, objectionable content (or content signals) may be blocked from being displayed on a particular display device 1310-1319. Finally, a display device may be blocked from receiving objectionable content (or content signals). Thus, although a content source may be configured to receive and send blocked content, display devices 1310-1316 may be blocked from receiving blocked content by a display control component where access authorization is denied. This capability is enabled particularly in an integrated IDMA/display unit.

As can be appreciated, a user may configure a display, a content source, or both to control access to content. In those examples where an external sending unit is provided, a user may configure an external sending unit to control access to content. The ability to control access on various devices allows a user to select between an appropriate or convenient device for configuration thus enhancing a viewers control options. Additionally, access limitations may be enabled in hardware, software, or both. Further, access control may be configured based on content criteria such as, for example, television parental ratings criteria, motion picture ratings criteria, user specified criteria, and destination device criteria. Still further, access may be limited by type. That is, access to certain types of content (e.g. television shows, game shows, sitcoms, etc.) may be limited. Still further, access may be configured for password identification, biometric identification, authorization key identification, or any other identification method well known in the art. Still further, access may be configured to configuration authorization levels such as administrative levels, user levels, and guest levels in some embodiments. As can be appreciated administrative levels generally enjoy wide access to controls and configurations; user levels enjoy person specific access to controls and configurations; and guest levels enjoy general and limited access to controls and configurations.

While this invention has been described in terms of several embodiments, there are alterations, permutations, and equivalents, which fall within the scope of this invention. It should also be noted that there are many alternative ways of implementing the methods and apparatuses of the present invention. For example, FIGS. 8-11 illustrate embodiments of the present invention utilizing only one aspect of the-present invention while combinations of any of the illustrated embodiments in FIGS. 8-11 may be configured without departing from the present invention. Thus, PVR 850 (FIG. 8) having an internal sending unit may be configured, as an example embodiment, with a number of content sources in configuration with an external sending unit.

Additionally, as noted for FIG. 13, each of the illustrated displays 1310-1314 is illustrated as receiving only one content signal from each content source. However, content sources may be configured to provide more than one content signal to a selected display. Thus, a display 1316 configured to receive more than one content signal (1326-1330) may receive those more than one content signals from a single content source 1308. Still further, as noted above, a content source may be further configured to provide functionality as a display. Still further a display may be further configured to provide functionality as a content source. Still further, a content source may be configured as any combination of integrate content sources such as a VCR/DVD combination for example. It is therefore intended that the following appended claims be interpreted as including all such alterations, permutations, and equivalents as fall within the true spirit and scope of the present invention.

What is claimed is:

1. An access control system for use with an intelligent data management arrangement (IDMA) comprising:
a source component for providing a content signal, the content signal originating from a content source;
a destination component for receiving the content signal; and
an IDMA in communication with the source component and the destination component, the IDMA comprising,
a content control component for controlling access of the content source, and
a display control component for controlling access of the destination component.

2. The access control system of claim 1 wherein the destination component is further configured to display the content signal on a destination device.

3. The access control system of claim 1 wherein the content control component is configured to block the content source from receiving the content signal.

4. The access control system of claim 1 wherein the content control component is configured to block the content source from sending the content signal.

5. The access control system of claim 2 wherein the content control component is configured to block the destination device from receiving the content signal.

6. The access control system of claim 2 wherein the content control component is configured to block the destination device from displaying the content signal.

7. The access control system of claim 1 wherein the content control component and the display control component are configured to control access based on content criteria selected from the group consisting of: television parental ratings criteria, motion picture ratings criteria, user specified criteria, and destination device criteria.

8. The access control system of claim 1 wherein the content control component and the display control component are configured to control access based on identification criteria selected from the group consisting of: password identification criteria, biometric identification criteria, and authorization key identification criteria.

9. The access control system of claim 1 wherein the content control component and the display control component are configured to control access based on authorization level criteria selected from the group consisting of: administrative level criteria, user level criteria, and guest level criteria.

10. The access control system of claim 1 wherein the content control component and the display control component are configured to control access based on type of content.

11. The access control system of claim 1 wherein the content source is selected from the group consisting of: a cable receiver, a video cassette recorder/player (VCR), a digital video disk recorder/player (DVD), a satellite receiver, a personal video recorder/player (PVR), an antenna, a stereo system, a radio, a personal computer, a digital storage system, a compact disc player, an Internet connection, a network connection, a game console, a camera, a camcorder, a phone system, a television, a network storage device, an electronic storage device, and a projector.

12. A method for controlling access in a distributed content system comprising:
receiving a content signal by a content source, the content source in communication with an intelligent data management arrangement (IDMA);
based on user selected criteria, performing, by the IDMA any of the following steps (a)-(f),
(a) blocking the content source from receiving the content signal,
(b) allowing the content source to receive the content signal,
(c) blocking the content source from sending the content signal,
(d) allowing the content source to send the content signal,
(e) blocking a destination device from displaying the content signal, and
(f) allowing the destination device to display the content signal; and
displaying the content source signal on a destination device in accordance with the performing of any of the following steps (a)-(f).

13. The method of claim 12 wherein the user selected content criteria is selected from the group consisting of: television parental ratings criteria, motion picture ratings criteria, user specified criteria, and destination device criteria.

14. The method of claim 12 wherein the user selected content criteria is selected from the group consisting of: password identification criteria, biometric identification criteria, and authorization key identification criteria.

15. The method of claim 12 wherein the user selected content criteria is selected from the group consisting of administrative level criteria, user level criteria, and guest level criteria.

16. The access control system of claim 12 wherein the content control component and the display control component are configured to control access based on type of content.

17. The method of claim 12 wherein the content device is selected from the group consisting of: a cable receiver, a video cassette recorder/player (VCR), a digital video disk recorder/player (DVD), a satellite receiver, a personal video recorder/player (PVR), an antenna, a stereo system, a radio, a personal computer, a digital storage system, a compact disc player, an Internet connection, a network connection, a game console, a camera, a camcorder, a phone system, a television, a network storage device, an electronic storage device, and a projector.

18. The method of claim 12 wherein the destination device is selected from the group consisting of: the display, the electronic storage device, and the content source.

19. A computer program product for use in conjunction with a computer system for controlling access in a distributed content system, the computer program product comprising a computer readable storage medium and a computer program mechanism embedded therein, the computer program mechanism comprising:
instructions for controlling access in a distributed content system comprising:
instructions for receiving a content signal by a content source, the content source in communication with an intelligent data management arrangement (IDMA);
based on user selected criteria, instructions for performing, by the IDMA any of the following steps (a)-(f),
(a) instructions for blocking the content source from receiving the content signal,
(b) instructions for allowing the content source to receive the content signal,
(c) instructions for blocking the content source from sending the content signal,
(d) instructions for allowing the content source to send the content signal,
(e) instructions for blocking a destination device from displaying the content signal, and
(f) instructions for allowing the destination device to display the content signal; and
instructions for displaying the content source signal on a destination device in accordance with the performing of any of the following steps (a)-(f).

20. The computer program product of claim 19 wherein the user selected content criteria is selected from the group consisting of: television parental ratings criteria, motion picture ratings criteria, user specified criteria, and destination device criteria.

21. The method of claim 19 wherein the user selected content criteria is selected from the group consisting of: password identification criteria, biometric identification criteria, and authorization key identification criteria.

22. The computer program product of claim 19 wherein the user selected content criteria is selected from the group consisting of administrative level criteria, user level criteria, and guest level criteria.

23. The computer program product of claim 19 wherein the content device is selected from the group consisting of: a cable receiver, a video cassette recorder/player (VCR), a digital video disk recorder/player (DVD), a satellite receiver, a personal video recorder/player (PVR), an antenna, a stereo system, a radio, a personal computer, a digital storage system, a compact disc player, an Internet connection, a network connection, a game console, a camera, a camcorder, a phone system, a television, a network storage device, an electronic storage device, and a projector.
